(19) United States
(12) Patent Application Publication
(10) Pub. No.: US 2019/0217308 A1
(43) Pub. Date: Jul. 18, 2019

(54) MOBILE PULVERIZER SYSTEM FOR FIREARMS AND HIGH STRENGTH MATERIALS

(71) Applicant: Gunbusters, LLC, Chesterfield, MO (US)

(72) Inventors: Raymond W. Reynolds, Chesterfield, MO (US); Jonas Bereisa, JR., Sunrise Beach, MO (US)

(21) Appl. No.: 15/873,407

(22) Filed: Jan. 17, 2018

(51) Int. Cl. B02C 21/02; H02J 7/00; H02J 7/02; H02J 7/35; H02P 5/00; B02C 25/00

(52) U.S. Cl. CPC B02C 21/02; H02J 7/0021; H02J 7/027; F41C 3/00; H02P 5/00; B02C 25/00; H02J 7/35

(57) ABSTRACT

A mobile firearms pulverizer system is disclosed having a mobile unit having an interior and an exterior, a pulverizer unit having a motor for operating the pulverizer unit with the pulverizer unit being in the interior of the mobile unit, a variable speed motor drive connected to the motor for controlling operation of the motor, a logic control for controlling operation of the variable speed motor drive, and a battery system for providing power to the logic control, the variable speed motor drive, and the motor.

### BACKGROUND

This disclosure relates to a system for destroying a firearm and more particularly to a mobile pulverizer system for destroying a firearm and other high strength materials and authenticating and recording the destruction of the firearm.

Every year numerous firearms are confiscated, surrendered, or seized by law enforcement agencies. While seizure and recovery numbers are not published, public ATF (Bureau of Alcohol, Tobacco, Firearms, and Explosives) and FBI (Federal Bureau of Investigation) data reflects over 364,000 crime guns were traced in 2016. On Sep. 29, 2017, the ATF reported a record 400,000 traces had been conducted in the first nine months of 2017. A recent study indicates at least 350,000 firearms are stolen annually, mostly from home burglaries and from vehicles. It is estimated that over a million guns are recovered annually by law enforcement, not including those obtained through agency buy-back programs. In some agencies, seized guns are stored for years or decades before a decision is made to dispose of the guns. Once the law enforcement agency no longer has a need to hold onto a confiscated or surrendered firearm, a decision is made to destroy the firearm. In many circumstances the Chief of Police or Sheriff is unable to find a satisfactory method to destroy the weapon. A decreasing number of agencies have been known to sell confiscated firearms to the highest bidder which in most cases are local gun dealers. However, some of these firearms turn back up in other crimes, sometimes involving the assault of an officer. The political ramifications are high and should be avoided.

In some agencies, seized guns are destroyed by sawing in-half or cutting with an acetylene torch. Other agencies destroy guns by crushing the gun with a sledge hammer. All of these methods are inherently dangerous tasks. A few agencies transport weapons to car shredders or foundries with an increased risk of loss or theft during the process. It is known that car shredders discharge large hunks of steel through which a small firearm may emerge unscathed by the process. It this occurs there is always the possibility that a supposedly shredded gun may reappear in a new crime. Some steel mills are no longer melting guns due to liability issues and environmental concerns. Since firearms may contain materials such as lead residue, cleaning chemicals, plastic, and treated wood parts, destruction of firearms may release potentially harmful chemicals when burned. As can be appreciated, there are sizable hidden costs for agencies that destroy firearms. For example, there are costs incurred for the packaging, shipping, storing, record-keeping, and eventual destruction of seized firearms. Some agencies, due to budgetary constraints, are not able to destroy firearms and must store or warehouse the confiscated weapons. A number of agencies recently increased the size of their storage rooms to store recovered firearms. Since the firearms are stored and not destroyed, there is the possibility of the firearms being misplaced or lost.

Further, once a firearm is destroyed, there is typically no record of the destruction of the firearm. For example, each firearm includes a unique identification number such as a serial number or an evidence identification number. However, once destroyed, there is no way to authenticate which firearm was destroyed or to check against a database to determine if a firearm had ever been destroyed.

The Applicant of the present application is also the owner of U.S. Pat. Nos. 8,890,944 and 9,106,809 in which various firearms pulverizer systems and methods were disclosed and claimed. In particular, the various firearms pulverizer systems destroyed a firearm and recorded and documented the destruction of the firearm. Other items, such as badges, computer hard drives, knives, license plates, and other items of evidence have also been destroyed and documented by these systems and methods. However, one drawback associated with the use of such firearms pulverizer systems and methods is that these items have to be transported from the agency to the destruction facility. Also, this can present high security risks in the transportation of large quantities of weapons by non-police or non-government personnel. Some agencies refuse the removal of firearms from the agency's facility or building to be transported to an off-site facility for destruction. As can be appreciated, the system for pulverizing firearms is rather large and heavy and it is remotely located from an agency's facility.

Another drawback related to the use of the firearms pulverizer systems and methods disclosed in U.S. Pat. Nos. 8,890,944 and 9,106,809 is that such systems require a large amount of power to run the motors associated with the systems. In particular, such motors are 20 to 30 kw motors that require 240/460/480 volts alternating current three phase electric grid power. Three phase power is an electric utility custom installation and is not typically found at a police department or a government building. A problem exists if the agency's facility does not have sufficient power to operate the motors associated with the pulverizer system or unit. Also, there are no safeguards associated with these systems to protect against drawing too much power. Further, there is a tremendous amount of noise generated by the pulverizer unit and due to the location of some agency's facilities this may not be acceptable.

In view of this, there is a need for a mobile firearms pulverizer system that provides its own three phase power. In particular, a diesel motor three phase generator should not be used because it is very large, weighs over two tons, and produces unacceptable noxious emissions and high intensity noise. Use of a compressed natural gas or propane motor three phase generator would produce less emissions but would still produce an unacceptable amount of noise and is still heavy and large. Commercially available battery systems with power electronics can provide three phase electric power and can provide the required amount of energy but cannot deliver the required power to run the motors during a shredding operation.

Therefore, it would be desirable to have a mobile firearms pulverizer system that is mobile and capable of providing the destruction of a firearm at an agency's facility or building. It would be advantageous to have a mobile firearms pulverizer system that is a self-contained mobile unit that can be transported to an agency's facility. It would also be advantageous to have a mobile firearms pulverizer system that is environmentally friendly and includes its own power supply for powering a pulverizer unit.

### SUMMARY

In one form of the present disclosure, a mobile pulverizer system is disclosed which comprises a mobile unit having an interior and an exterior, a pulverizer unit having a motor for operating the pulverizer unit with the pulverizer unit being in the interior of the mobile unit, a variable speed motor drive connected to the motor for controlling operation of the motor, a logic control for controlling operation of the variable speed motor drive, and a battery system for providing power to the logic control, the variable speed motor drive, and the motor.

In another form of the present disclosure, a firearms pulverizer system comprises a mobile unit having an interior and an exterior, a pulverizer unit having a motor for operating the pulverizer unit with the pulverizer unit being in the interior of the mobile unit, a variable speed motor drive connected to the motor for controlling operation of the motor, a logic control for controlling operation of the variable speed motor drive, a battery system for providing power to the logic control, the variable speed motor drive, and the motor, and a solar power system for providing power to the battery system.

In yet another form of the present disclosure, a mobile firearms pulverizer system is disclosed which comprises a mobile unit having an interior and an exterior, a pulverizer unit having a first motor and a second motor with the motors for operating the pulverizer unit with the pulverizer unit being in the interior of the mobile unit, a first variable speed motor drive connected to the first motor for controlling operation of the first motor, a second variable speed motor drive connected to the second motor for controlling operation of the second motor, a logic control for controlling operation of the first and second variable speed motor drives, a battery system for providing power to the logic control, the variable speed motor drive, and the motor, and a charging system for charging the battery system.

In light of the foregoing comments, it will be recognized that the present disclosure provides a mobile pulverizer system for destroying a firearm at a remote location.

The present disclosure provides a mobile firearms pulverizer system for authenticating a firearm being destroyed and for recording the destruction of the firearm.

The present disclosure provides a mobile firearms pulverizer system which is mobile and may be transported to an agency's storage facility for use and operation.

The present disclosure provides a mobile firearms pulverizer system that provides a database of destroyed firearms with the database being used to check against other weapons databases.

The present disclosure provides a mobile firearms pulverizer system that enables a law enforcement agency to easily, safely, efficiently, and cost-effectively destroy confiscated, surrendered, or seized firearms at the location of the law enforcement agency.

The present disclosure is related to a mobile firearms pulverizer system that contains its own power supply to provide power to a pulverizer system incorporated into the mobile system.

The present disclosure is also directed to a mobile firearms pulverizer system that is capable of destroying other items such as badges, computer hard drives, knives, license plates, and other items of evidence.

The present disclosure provides a mobile firearms pulverizer system that includes multiple power supplies and storage devices for providing power to a pulverizer unit incorporated into the mobile system.

The present disclosure also provides a mobile firearms pulverizer system that may be connected to an electric power grid to charge the system.

The present disclosure is further directed to a mobile firearms pulverizer system that can be charged by a self-contained solar panel system.

These and other advantages of the present system and method for implementing a mobile firearms pulverizer system will become apparent after considering the following detailed specification in conjunction with the accompanying drawings, wherein:

### BRIEF DESCRIPTION OF THE DRAWINGS

FIG. 1 is a block diagram of a mobile firearms pulverizer system constructed according to the present disclosure;

FIG. 2 is a front view of an operator control panel for the mobile firearms pulverizer system constructed according to the present disclosure;

FIG. 3 is a front view of a system control panel for the mobile firearms pulverizer system constructed according to the present disclosure;

FIG. 4 is a front view of a battery state of health display for the mobile firearms pulverizer system constructed according to the present disclosure; and

FIG. 5 is a side perspective view of a mobile firearms pulverizer unit for the mobile firearms pulverizer system constructed according to the present disclosure;

### DETAILED DESCRIPTION OF THE PREFERRED EMBODIMENTS

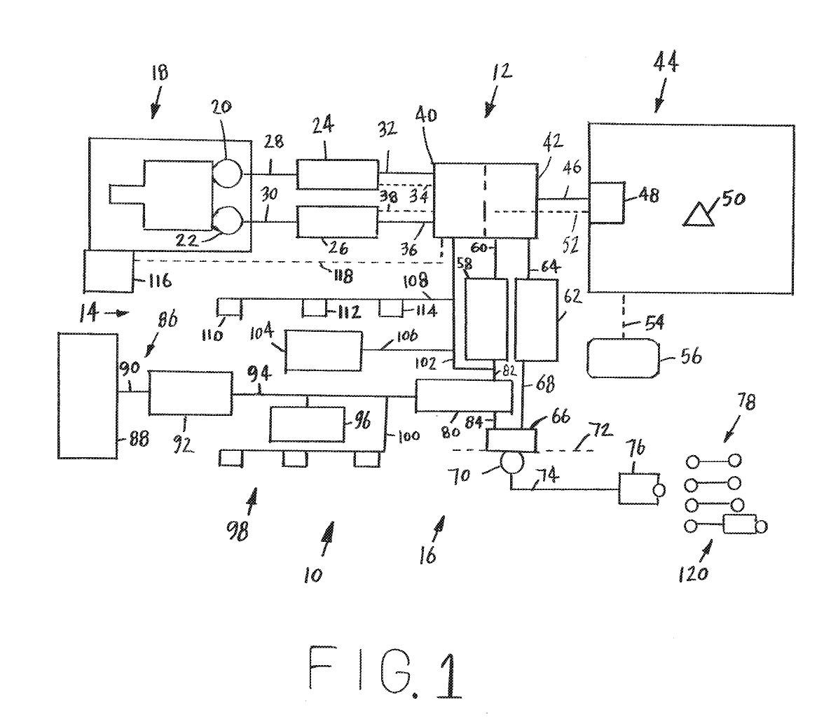

Referring now to the drawings, wherein like numbers refer to like items, number 10 identifies a mobile firearms pulverizer system constructed according to the present disclosure. With reference now to FIG. 1, the system 10 is shown to comprise a mobile vehicle or unit 12 having an interior 14 and an exterior 16. Examples of the mobile vehicle 12 may be a truck, a trailer, a semi-trailer, a class 8 tractor trailer, a container mounted on a drop-off flat bed trailer, a container on skids for drop-off, or a van. The system 10 has a firearms pulverzier unit 18 installed within the interior 14. Examples of a firearms pulverizer unit 18 are found in U.S. Pat. Nos. 8,890,944 and 9,106,809, which are owned by the Applicant of this application. Further, the disclosures of U.S. Pat. Nos. 8,890,944 and 9,106,809 are incorporated herein by this reference. The firearms pulverizer unit 18 is powered by a pair of electric motors 20 and 22. The electric motors 20 and 22 may each be a three phase alternating current (AC) motor such as 20 to 30 kw motors. Examples of the electric motors 20 and 22 may be motors manufactured by NIDEC Motor Corporation having a model number of DX59 #U20P20CR. The electric motors 20 and 22 are each connected to a pair of variable speed motor drives 24 and 26, respectively. The drive 24 is connected to the motor 20 by use of a wire 28. The drive 26 is connected to the motor 22 via a wire 30. The drive 24 is connected to a system control panel 30 by a connection 32 and a digital connection or link 34. The drive 26 is also connected to the system control panel 30 by a connection 36 and a digital connection 38. Examples of the drives 24 and 26 may be drives manufactured by ABB having a model designation ACS 880. The system control panel 30 includes a logic control 40 and a junction box 42. The junction box 42 of the system control panel 30 is connected to a high voltage, high current battery pack or system 44 by a connection 46. The battery pack 44 may comprise cells, such as lithium ion, that may be grouped in parallel to deliver high current and parallel groups arranged in series to provide high voltage thereby achieving a power to energy ratio of 2:1 or more. The battery pack 44 provides sufficient energy to operate the unit 18. The battery pack 44 is also much less than the size and weight of a diesel generator or a compressed gas or propane generator. Also, the battery back 44 has zero emissions and produces zero noise. An example of the battery pack 44 is a Nissan Leaf 360 VDC 34 KWHR battery pack having a part number of 290J03NA1A. The battery pack 44 includes a number of main power relays 48 which are connected to the junction box 42 by the connection 46. The battery pack 44 also contains a safety high voltage disconnect 50 for maintenance. A digital connection 52 connects the main power relays 48 to the logic control 40 to provide an on/off signal. A digital connection or digital data bus 54 is also provided from the battery pack 44 to a display 56. The display 56 is used to indicate the state of health of the battery pack 44. An example of the display 56 may be an Apple iPad 2017 Wifi 32 G.

The junction box 42 is also used to be connected to a 120 volts alternating current (VAC) single phase charger 58 over a connection 60. An example of the charger 58 is a TDK Lambda high voltage programmable power supply Gen 600-1.3. A 240 VAC single phase charger 62 is connected to the junction box 42 by use of a connection 64. An example of the charger 62 is a TDK Lambda high voltage programmable power supply Gen 600-5.5. The 240 VAC single phase charger 62 is connected to a connector 66 through a connection 68. The connector 66 may have a socket 70 that is present on an exterior wall 72 of the mobile vehicle 12. The connector 66 may receive 240 VAC single phase over a 240 VAC 30 ampere four wire extension cord 74. An example of an available extension cord that can be used as the extension cord 74 is a Contek 20603 L14-30 cord. An integral ground fault circuit interrupter (GFCI) and circuit breaker device 76 is also provided for safety and to meet electrical codes. The device 76 is connected to the power grid 78. The 120 VAC single phase charger 58 is connected to a combination direct current/alternating current (DC/AC) inverter and charger device 80 over a connection 82. An example of the charger device 80 is a Xantrex 807-2055 Freedom HFS 2000 W. The combination DC/AC inverter and charger device 80 may receive power from a pair of sources. The first source is from the power grid 78 through the socket 70 and the connector 66 over a connection 84. The second source is from a solar power system 86. The solar power system 86 has a solar panel 88 that may be positioned on the exterior 16 of the mobile unit 12. By way of example only, the solar panel 88 may be positioned on a roof of the mobile unit 12. Also, although the solar panel 88 is shown, it is possible and contemplated that a number of solar panels may be provided, as is known in solar power systems. The solar panel 88 is capable of providing direct current (DC) electric power, such as 48 volts DC (VDC), over a connection 90 to a DC/DC converter 92. It is also possible that the solar panel 88 is capable of providing other amounts of DC electric power such as 36, 60, or 96 VDC. The DC/DC converter 92 steps down the 48 VDC to 12 VDS and provides 12 VDC over a connection 94 to the combination DC/AC inverter and charger 80 and a 12 VDC battery 96. An example of the battery 96 is a Duracell AGM deep cycle marine and RV 12 volt 105 amp hour battery. Although one battery 96 is shown it is possible to have more than one battery 96. Interior lights, such as light emitting diode (LED) lights 98 may be provided to illuminate the work place interior from the 12 VDC battery 96 over a connection 100. The combination DC/AC inverter and charger 80 provides 120 VAC single phase over a branch 102 from the connection 82. The branch 102 provides 120 VAC single phase to an air conditioning and heat (AC/Heat) unit 104 over a branch 106 of the branch 102. The unit 104 is provided in the interior 14 of the vehicle unit 12 to provide air conditioning and heat for individuals within the vehicle unit 12 who may be operating the firearms pulverizer unit 18. Another branch 108 off of the branch 102 provides 120 VAC single phase power to three 120 VAC standard outlets 110, 112, and 114. The outlets 110, 112, and 114 may be used to have various other devices (not shown) plugged into the outlets 110, 112, and 114 to power the various other devices. The branch 102 is also connected to the logic control 40 of the system control panel 40. An operator control panel 116 is used to control operation of the firearms pulverizer unit 18. A digital connection 118 is provided between the operator control panel 116 and the logic control 40 to control various operations of the system control panel 30. As can be appreciated, for the sake of clarity, some of the connections between the various components of the system 10 have not been shown in detail.

The system 10 may also be connected to an Electric Vehicle Level 2. Charge Station (SAE J-1772) connection 120 to be able to charge the battery pack 44. In particular, the facility where the system 10 is transported to may have the connection 120 available to charge the battery pack 44. The charging capability of the system 10 is now expanded to include any 120 VAC single phase outlet (15, 20 amp), any 240 VAC single phase outlet (30, 45 amp), any Electric Vehicle Level 2. Charge Station connection (240 VAC single phase 30, 50 amp), or solar power. The various charging locations may be located at any building having an electric grid outlet, any recreational vehicle (RV) park electric hook up, any designated Electric Vehicle (EV) parking space equipped with electric vehicle service equipment (SAE J-1772 EVSE) for charging, and any open space in which sunlight is provided for using the solar power system 86.

The system 10 has the following modes of operation. In a first mode, the system 10 is all off. In this mode the battery pack 44 is not charging. In a second mode, the solar power system 86 is charging the battery pack 44 and all of the other components of the system 10 are off. In a third mode, the system 10 is operating and the system 10 is not connected to the power grid 78. In essence, the system 10 is running off of the power provided from the battery pack 44. In a fourth mode, the system 10 is connected to the power grid 78 and the 240 VAC charger 62 is being used to charge the battery pack 44. The system 10 is also operational and running off of the battery pack 44. In a fifth mode, the system 10 is connected to the power grid 78 and the 120 VAC charger 58 is being used to charge the battery pack 44. The battery pack 44 is powering the system 10 and the system 10 is capable of operating. In a sixth mode, the system 10 is off, is connected to the power grid 78, and the 240 VAC charger 62 is charging the battery pack 44. In a seventh mode of operation, the system 10 is off, is connected to the power grid 78, and the 120 VAC charger 58 is being used to charge the battery pack 44. In an eighth mode, the system 10 is running off of the battery pack 44 and the solar power system 86 is charging the battery pack 44. As can be appreciated by the above various modes of operation, the system 10 does not have to be connected to the power grid 78 to be operational. Connection of the system 10 to the power grid 78 may be required to charge the battery pack 44 in cases where the solar power system 86 is not provided in the system 10. The system 10 may operate at the same time the battery pack 44 is being charged by either being connected to the power grid 76 or being connected to the solar power system 86. As can be appreciated, other modes of operation are possible, such as being connected to the connection 120, and the above noted modes are only for purposes of example.

The system 10 may be connected to the power grid 78 by use of the extension cable 74 that simplifies connection to all types of electric power outlets that may be encountered at a remote location. The extension cable 74 can utilize a series of short (18 inches) pigtail connection adapters that plug into different voltage and current rating building power outlets (120 VAC and 240 VAC, 20 to 45 amperes) on one end and on the other end to a fixed master termination box physically hard wired to the extension cable 74 for safety. The integral GFCI and circuit breaker device 76 is used to protect against ground faults and over current conditions when the system 10 is connected to the power grid 78. The extension cable 74 can be 100 to 200 feet in length having an abrasion proof outer sheath or covering rated for wet environments. The extension cable 74 can have an internal four wire configuration having a first phase wire, a second phase wire, a neutral wire, and a ground wire.

Charging or operation of the system 10 off of 240 VAC power is as follows. The extension cable 74 is connected to a 240 VAC outlet associated with the power grid 78. 240 VAC will now be provided to the system 10 at the socket 70 that is present on an exterior wall 72 of the mobile vehicle 12. An operator of the system 10 may select to either charge the battery pack 44 by use of the 240 VAC power (sixth mode) or run the system 10 and also charge the battery pack 44 (fourth mode). The logic control 40 turns on the 240 VAC charger 62 to charge the battery pack 44. Charging of the battery pack 44 proceeds in a preset constant current mode until a preset voltage limit is reached or detected. Charging will then proceed slowly at a constant voltage. The system 10 will monitor various factors and will automatically shut down the charger 62 if a battery over voltage condition is detected, or a battery over temperature condition is detected, or an individual battery cell is out of a voltage limit is detected. The presence of 120 VAC (phase to neutral) at the socket 70 will also be concurrently automatically detected by the combination DC/AC inverter and charger device 80. The device 80 switches to 12 VDC charger mode to charge the high capacity 12 V battery 96. Charging proceeds constant current followed by constant voltage mode. 120 VAC from the power grid 78 will automatically be available to power control electronics, such as the logic control 40, interior equipment connected to the outlets 110, 112, and 114, and the AC/Heat unit 104.

Charging or operation of the system 10 from 120 VAC single phase power is as follows. The extension cable or cord 74 is connected to a 120 VAC outlet associated with the power grid 78. 120 VAC will now be provided to the system 10 at the socket 70 that is present on an exterior wall 72 of the mobile vehicle 12. An operator of the system 10 may select to either charge the battery pack 44 by use of the 120 VAC power (seventh mode) or run the system 10 and also charge the battery pack 44 (fifth mode). The logic control 40 turns on the 120 VAC charger 58 to charge the battery pack 44. Charging of the battery pack 44 proceeds in a preset constant current mode until a preset voltage limit is reached or detected. Charging will then proceed slowly at a constant voltage. The system 10 will monitor various factors and will automatically shut down the charger 58 if an over voltage condition is detected, or an over temperature condition is detected, or an individual battery cell is out of a voltage limit is detected. The presence of 120 VAC (phase to neutral) at the socket 70 will be automatically detected by the combination DC/AC inverter and charger device 80. The device 80 switches to 12 VDC charger mode to charge the high capacity 12 V battery 96. Charging proceeds constant current followed by constant voltage mode. 120 VAC from the power grid 78 will automatically be available to power control electronics, such as the logic control 40, interior equipment connected to the outlets 110, 112, and 114, and the AC/Heat unit 104.

The solar power system 86 may be an optional feature of the system 10. Charging or operation of the system 10 off of the solar power system 86 may be accomplished as follows. An operator of the system 10 may select to either charge the battery pack 44 by use of the solar power system 86 (second mode) or run the system 10 and also charge the battery pack 44 (eighth mode). The solar panel 88 is capable of provided 48 VDC to the DC/DC converter 92. The converter 92 is used to step down the voltage to charge the 12 VDC battery 96. The device 80 automatically detects a lack of 120 VAC from the power grid 78 and switches to an inverter mode. Once in inverter mode the device 80 will convert 12 VDC power into single phase 120 VAC. 120 VAC will then be available to power control electronics, such as the logic control 40, interior equipment connected to the outlets 110, 112, and 114, and the AC/Heat unit 104. The 120 VAC charger 58 will be connected to internal 120 VAC.

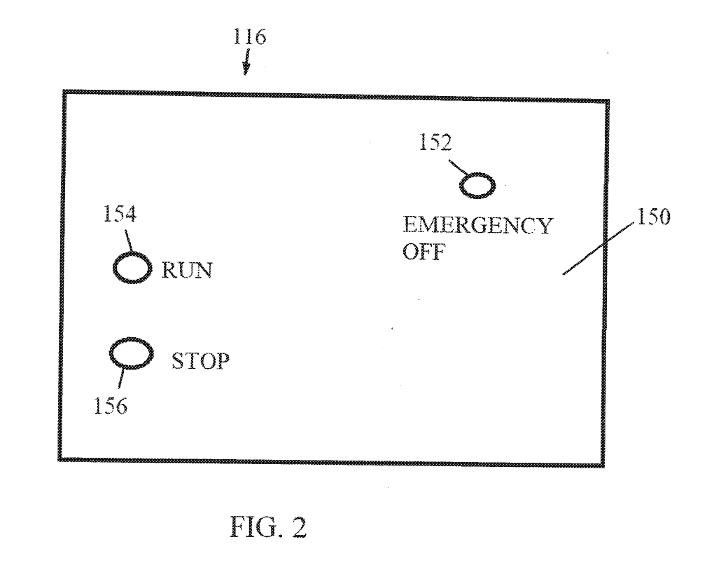

FIG. 2 is a front view of the operator control panel 116 is shown. The operator control panel 116 has a panel 150 having an emergency off button or switch 152, a run button or switch 154, and a stop button or switch 156. The buttons 152, 154, and 156 may also be lit having various colors to provide a visual indication to an operator of the status of the unit 18. For example, the run button 154 may be a green color. Although only the buttons 152, 154, and 156 are shown it is possible to have other buttons or switches. It is also contemplated that the panel 150 may be a touch sensitive screen so that various other screens, menus, or options may be presented as part of the operator control panel 116.

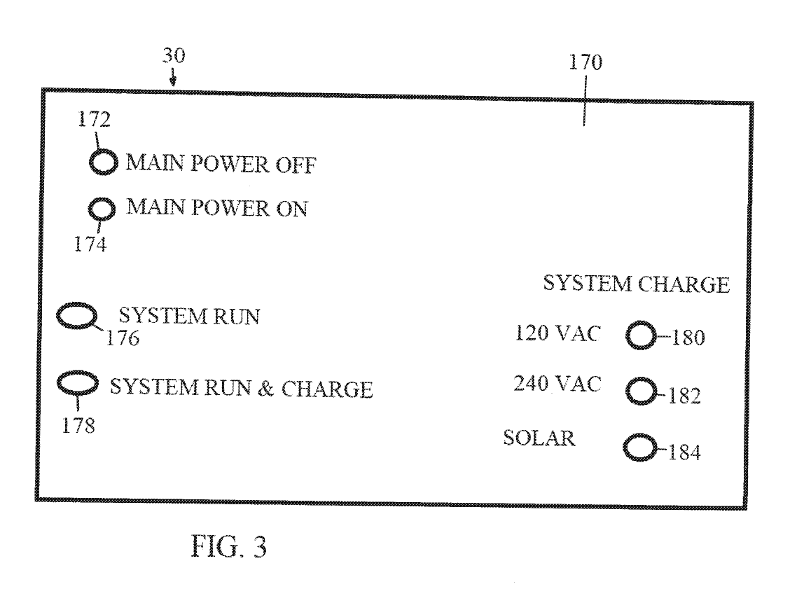

Referring now to FIG. 3, a front view of the system control panel 30 is illustrated. The system control panel 30 has a panel 170 having a main power off button or switch 172, a main power on button or switch 174, a system run button or switch 176, a system run and charge button or switch 178, a 120 VAC system charge button or switch 180, a 240 VAC system charge button or switch 182, and a solar charge button or switch 184. The buttons 172, 174, 176, 178, 180, and 182 may also be lit having various colors to provide a visual indication to an operator of the status of the system 10. For example, the run button 174 may be a green color. Although only the buttons 172, 174, 176, 178, 180, 182, and 184 are shown it is possible to have other buttons or switches. It is also contemplated that the panel 170 may be a touch sensitive screen so that various other screens, menus, or options may be presented as part of the system control panel 30.

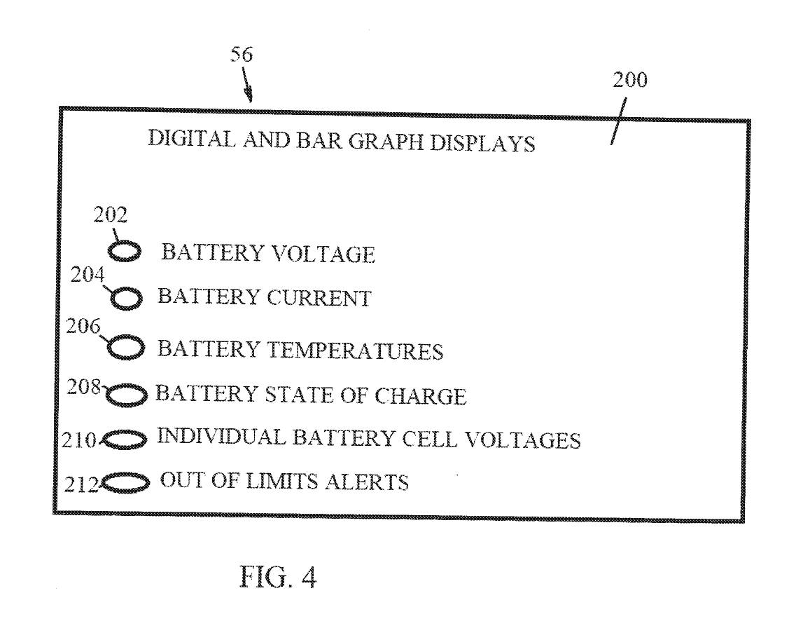

FIG. 4 depicts a front view of the battery state of health display 56. The display 56 has a touch sensitive panel 200 that is capable of providing various digital and bar graphs of the status of a battery voltage 202, a battery current 204, a battery temperature 206, a battery state of charge 208, an individual battery cell voltage 210, and an out of limit alert 212. By use of the display 56 the status of various components associated with the battery pack 44 of the system 10 may be viewed and monitored. For example, by selecting the battery voltage 202 on the panel 200, a new screen (not shown) will be presented that provides either a digital graph or a bar graph of the status of the battery voltage of the battery pack 44. It is also possible that the panel 200 may have other screens, menus, or options to be able to control operation of the display 56.

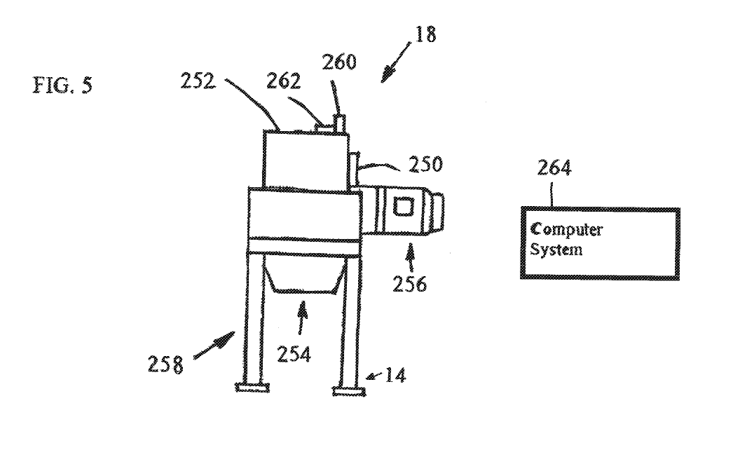

With reference now to FIG. 5, a front perspective view of the firearms pulverizer unit 18 is illustrated. As has been indicated, the unit 18 is installed in the interior 14 of the mobile unit 12. The unit 18 is shown to comprise an inlet chute 250, a cutting chamber 252, and an outlet 254. The pulverizer unit 18 may include a drive assembly 256 for operating the cutting chamber 252. The drive assembly 256 includes the electric motors 20 and 22 (FIG. 1). The pulverizer unit 18 may be positioned on a base unit 258. The base unit 258 may be and anchored to the interior 14. It is also possible and contemplated that the base unit 258 may be positioned on a lockable in place pallet, wheels, or a wheeled assembly to allow the firearms pulverizer system 18 to be removed from the interior 14 of the mobile unit 12 for maintenance, repair, or replacement. An example of a suitable pulverizer unit 18 is a machine manufactured by American Pulverizer Company of St. Louis, Mo. identified as model number TRS-24X25-EG-HD-DE Series II.

The pulverizer unit 18 also comprises an image capturing device or camera 260 that is capable of being positioned above the inlet chute 250 and repositioned above the cutting chamber 252. Although one camera 260 is shown, it is possible and contemplated that two or more cameras may be used to record the destruction of an item inserted into the pulverizer unit 18. The image capturing device 260 is used for capturing an image of an identification number associated with a firearm and for recording destruction of a firearm inserted into the cutting chamber 252. An example of the camera 260 that may used is a Logitech HD webcam c615. The camera 260 may be attached to a sliding mechanism 262 that allows the camera 260 to be moved from a first position over the inlet chute 250 to a second position over the cutting chamber 252. In the first position over the inlet chute 250, an operator is able to record the identification number associated with a firearm. When the camera 260 is moved to the second position, the camera 260 is capable of recording the destruction of a firearm placed into the cutting chamber 252. It is also possible that the sliding mechanism 262 may not be used and that the camera 260 may just be moved from the first position over the inlet chute 250 to the second position over the cutting chamber 252 and back.

The system 10 also comprises a computer system 264 that is connected to the image capturing device 260. The connection between the computer system 264 and the camera 260 may be wired or wireless. In this particular view the computer system 264 is depicted as being a wireless connection. The computer system 264 may have a screen, such as the operator control panel 116 (FIG. 1), upon which various operation screens may be presented. By way of example, the computer system 264 may be a computer having a microprocessor, memory, a hard drive having stored thereon an operating system and other software programs, input devices such as a mouse or a touch screen, a DVD Multi-recorder drive, and a floppy disk drive. The computer system 264 may also include other ancillary devices such as a printer, a scanner, a modem, a router, or other network devices that allow the computer system 264 to be connected to a network or the Internet. It is also possible that the computer system 264 may be a laptop computer, a smart phone, an iPod touch, a personal digital assistant (PDA), an iPad, tablet, an Android based tablet, a device that has WiFi connectivity, or other mobile communications device capable of sending and receiving data over a wireless network. It is also possible that the computer system 264 may use various connections to send data or information to a secured facility and the connections may take on various forms such as a telephone line, cable, ISDN lines, fiber optic lines, wireless connections, microwave, radio, satellites, or military or law enforcement secured lines.

The operation of the system 10 may take place as follows. The system 10 will be transported to a facility that has requested the destruction of various items such as firearms, badges, hard drives, or other items of evidence that are no longer needed to be stored. An operator may connect the extension cable 74 to the power grid 78 to provide power to the system 10 to charge the battery pack 44, if required or desired. If an outlet is not provided or available it is also possible that if the mobile vehicle 12 has been fitted with the solar power system 86 that the solar panel 88 may be employed. Power will be provided from the battery pack 44 to the motors 20 and 22 and to various other components in the system 10. An operator may use the operator control panel 116 to control operation of the various components of the system 10. If a firearm needs to be destroyed then the following may occur. Once an identification number of a firearm to be destroyed is captured and recorded by the camera 260, the camera 260 is repositioned over the cutting chamber 252. Once an operator verifies that the camera 260 is recording the cutting chamber 252, an operator can drop a firearm to be destroyed through the inlet chute 250 to be destroyed in the cutting chamber 252. The camera 260, which is now positioned over the cutting chamber 252, will record the destruction of a firearm. Once a firearm is destroyed, any remnants will be discharged by the outlet 254. A container (not shown) may be placed beneath the outlet 254 for capturing, collecting, and storing any remnants for further disposal or sale. When another firearm needs to be destroyed, the camera 260 is moved back to over the inlet chute 250 and the process is repeated again. It is to be noted that this process takes place all within the interior 14 of the mobile unit 12. As has been disclosed in the above identified patents, U.S. Pat. Nos. 8,890,944 and 9,106,809, various other constructions and components of the firearms pulverizer unit 18 are possible and contemplated.

The system 10 may also include the following safety devices and features. All internal connections and wiring will be provided per standard electrical codes and all wiring will be enclosed in conduit. All electrical equipment will be grounded and bonded. All circuits may be protected by circuit breakers or fuses. The battery pack 44 may be visually marked to indicate that safe disconnect device 50 may be manually operated to disconnect power from the battery pack 44. An operator of the system 10 has ready access to operate the emergency off button or switch 152 in an emergency situation. A low state of charge (low voltage) condition for the battery pack 44 may be automatically detected by a DC to three phase AC inverter which will initiate shut down of the system 10. An over voltage/over temperature condition of the battery pack 44 may be automatically detected by the chargers 58 and 62 to force the chargers 58 62 to power off. The battery state of health display 56 provides data concerning the state of health of the battery pack 44. In particular, the display 56 visually indicates the voltage, current, state of charge, individual cell voltages, and temperature of the battery pack 44. The display 56 may wireless connected to the battery pack 44 to provide for a remote positioning of the display 56. Also, the electrical equipment may be protected by an automatic sense fire extinguisher rated for electrical fires.

From all that has been said, it will be clear that there has thus been shown and described herein a mobile firearms pulverizer system and method which fulfills the various advantages sought therefore. It will become apparent to those skilled in the art, however, that many changes, modifications, variations, and other uses and applications of the subject mobile firearms pulverizer system and method are possible and contemplated. All changes, modifications, variations, and other uses and applications which do not depart from the spirit and scope of the disclosure are deemed to be covered by the disclosure, which is limited only by the claims which follow.

What is claimed is:

1. A mobile firearms pulverizer system comprising:
a mobile unit having an interior and an exterior;
a pulverizer unit having a motor for operating the pulverizer unit with the pulverizer unit being in the interior of the mobile unit;
a variable speed motor drive connected to the motor for controlling operation of the motor;
a logic control for controlling operation of the variable speed motor drive; and
a battery system for providing power to the logic control, the variable speed motor drive, and the motor.

2. The mobile firearms pulverizer system of claim 1 wherein the logic control further comprises a system control panel and a junction box.

3. The mobile firearms pulverizer system of claim 1 wherein the battery system comprises a number of batteries, a main power relay, and a safety disconnect.

4. The mobile firearms pulverizer system of claim 1 further comprising a charger for charging the battery system.

5. The mobile firearms pulverizer system of claim 1 wherein the battery system further comprises a battery state of health display.

6. The mobile firearms pulverizer system of claim 1 further comprising an operator control panel.

7. The mobile firearms pulverizer system of claim 1 further comprising a 120 VAC single phase charger for charging the battery system.

8. The mobile firearms pulverizer system of claim 1 further comprising a 240 VAC single phase charger for charging the battery system.

9. A mobile firearms pulverizer system comprising:
a mobile unit having an interior and an exterior;
a pulverizer unit having a motor for operating the pulverizer unit with the pulverizer unit being in the interior of the mobile unit;
a variable speed motor drive connected to the motor for controlling operation of the motor;
a logic control for controlling operation of the variable speed motor drive;
a battery system for providing power to the logic control, the variable speed motor drive, and the motor; and
a solar power system for providing power to the battery system.

10. The mobile firearms pulverizer system of claim 9 wherein the solar power system further comprises a solar panel positioned on the exterior of the mobile unit.

11. The mobile firearms pulverizer system of claim 9 wherein the solar power system further comprises a solar panel connected to an DC/DC converter which is connected to a 12 VDC battery.

12. The mobile firearms pulverizer system of claim 9 wherein the solar power system further comprises a solar panel connected to an DC/DC converter which is connected to a combination DC/AC inverter and charger device.

13. The mobile firearms pulverizer system of claim 9 wherein the pulverizer unit further comprises an operator control panel for controlling operation of the pulverizer unit.

14. The mobile firearms pulverizer system of claim 9 wherein the battery system comprises a number of batteries, a main power relay, and a safety disconnect.

15. The mobile firearms pulverizer system of claim 9 further comprising a charger for charging the battery system.

16. A mobile firearms pulverizer system comprising:
a mobile unit having an interior and an exterior;
a pulverizer unit having a first motor and a second motor with the motors for operating the pulverizer unit with the pulverizer unit being in the interior of the mobile unit;
a first variable speed motor drive connected to the first motor for controlling operation of the first motor;
a second variable speed motor drive connected to the second motor for controlling operation of the second motor;
a logic control for controlling operation of the first and second variable speed motor drives;
a battery system for providing power to the logic control, the variable speed motor drive, and the motor; and
a charging system for charging the battery system.

17. The mobile firearms pulverizer system of claim 16 wherein the charging system comprises a 120 VAC single phase charger.

18. The mobile firearms pulverizer system of claim 16 wherein the charging system comprises a 240 VAC single phase charger.

19. The mobile firearms pulverizer system of claim 16 wherein the battery system comprises a number of batteries, a main power relay, a safety disconnect, and a battery state of health display.

20. The mobile firearms pulverizer system of claim 16 further comprising an operator control panel.
